(19) United States
(12) Patent Application Publication
(10) Pub. No.: US 2026/0271137 A1
(43) Pub. Date: Sep. 10, 2026

(54) HEATING LUNCH BOX

(71) Applicant: Zhe Cai, Shenzhen (CN)

(72) Inventor: Zhe Cai, Shenzhen (CN)

(21) Appl. No.: 19/540,628

(22) Filed: Feb. 14, 2026

Related U.S. Application Data
(63) Continuation-in-part of application No. 19/345,455, filed on Sep. 30, 2025, now Pat. No. 12,672,208.
Application No. 19/345,455 is a continuation of application No. 19/074,034, filed on Mar. 7, 2025, now Pat. No. 12,457,665.

(30) Foreign Application Priority Data
Nov. 6, 2025 (CN) 202522367060.3

(51) Int. Cl. H05B 1/02; B65D 43/02; B65D 81/34

(52) U.S. Cl. CPC H05B 1/0261; B65D 43/0212; B65D 81/3476; H05B 1/0225; B65D 2543/00712

(57) ABSTRACT

A heating lunch box includes: a main body, defining a heating chamber therein and forming a mounting port; a container box, detachably mounted in the heating chamber and defining a containing chamber therein for receiving food; a heating module, mounted in the main body and configured to heat the container box; a touch screen module, mounted in the mounting port of the main body; a built-in power supply, mounted in the main body; a power switch, configured to turn on or off the built-in power supply; and a control board, electrically connected to the heating module, the touch screen module, the built-in power supply, and the power switch.

### CROSS-REFERENCE TO RELATED APPLICATIONS

The present disclosure is a continuation-in-part of the U.S. patent application Ser. No. 19/345,455, filed on Sep. 30, 2025, and claims the priority of the Chinese patent application No. 202522367060.3, filed on Nov. 6, 2025. The U.S. patent application Ser. No. 19/345,455 is a continuation of U.S. patent application Ser. No. 19/074,034, filed on Mar. 7, 2025. Contents of which are incorporated herein by their entireties.

### TECHNICAL FIELD

The present invention relates to the technical field of food containers, particularly to a heating lunch box.

### BACKGROUND ART

A lunch box in the art may have a basic heat insulation capability. When a user is about to eat food in the lunch box, the food inside the lunch box may be cooled, and the user may use a heating tool to heat the food inside the lunch box. However, in certain public spaces, limited heating tools may be provided, and the user may need to wait for a longer period of time to heat the food inside the lunch box. In some cases, no heating tool may be provided, and the food cannot be heated at all.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a heating lunch box includes: a main body, defining a heating chamber therein and forming a mounting port; a container box, detachably mounted in the heating chamber and defining a containing chamber therein for receiving food; a heating module, mounted in the main body and configured to heat the container box; a touch screen module, mounted in the mounting port of the main body; a built-in power supply, mounted in the main body; a power switch, configured to turn on or off the built-in power supply; and a control board, electrically connected to the heating module, the touch screen module, the built-in power supply, and the power switch.

### BRIEF DESCRIPTION OF THE DRAWINGS

Illustrative embodiments of the present disclosure are described in detail below with reference to the attached drawing figures.

FIG. 1 is a flow diagram of an embodiment of the present invention.

FIG. 2 is a flow diagram of step S40 of the present invention.

FIG. 3 is a flow diagram of step S43 of the present invention.

FIG. 4 is a flow diagram of step S50 of the present invention.

FIG. 5 is a flow diagram after step S10 of the present invention.

FIG. 6 is a flow diagram in step S10 of the present invention.

FIG. 7 is a schematic diagram of a structure of a heating lunch box.

FIG. 8 is an exploded view of a structure of a heating lunch box.

FIG. 9 is a schematic diagram of a structure of an upper cover of a heating lunch box.

FIG. 10 is a module diagram of a heating lunch box.

FIG. 11 is a diagram of an initial interface of a heating lunch box.

FIG. 12 is a diagram of a heating interface of a heating lunch box.

FIG. 13 is an interface diagram for setting a heating time of a heating lunch box.

FIG. 14 is a structural schematic view of an entirety of the heating lunch box of an embodiment of the present invention.

FIG. 15 is an exploded view of the heating lunch box of an embodiment of the present invention.

FIG. 16 is a structural schematic view of a main body of the heating lunch box and a touch screen module being connected to each other according to an embodiment of the present invention.

FIG. 17 is an exploded view I of the touch screen module of an embodiment of the present invention.

FIG. 18 is an exploded view II of the touch screen module of an embodiment of the present invention.

FIG. 19 is a cross-sectional view of the main body of the heating lunch box and the touch screen module according to an embodiment of the present invention.

FIG. 20 is an enlarged view of a portion A in FIG. 19.

FIG. 21 is a structural schematic view I of a cover body, a box body, and the main body of the heating lunch box, being connected to each other according to an embodiment of the present invention.

FIG. 22 is a structural schematic view II of the cover body, the box body, and the main body of the heating lunch box, being connected to each other according to an embodiment of the present invention.

FIG. 23 is a structural schematic view III of the cover body, the box body, and the main body of the heating lunch box, being connected to each other according to an embodiment of the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

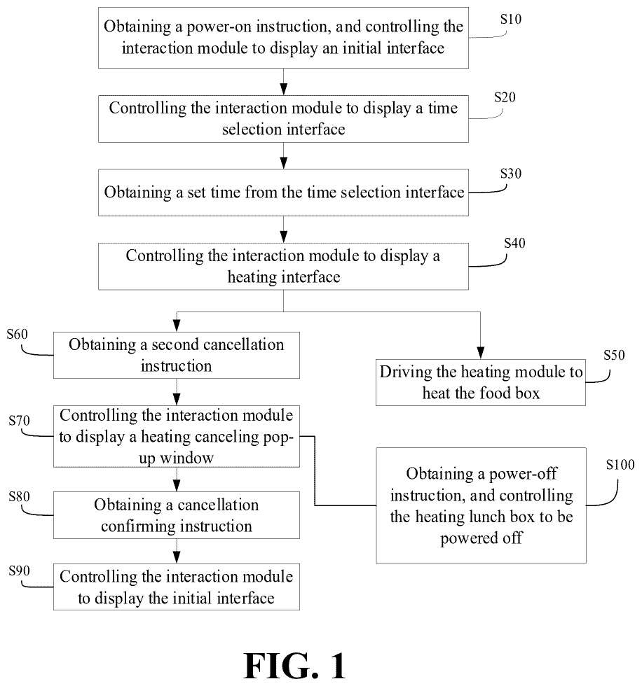

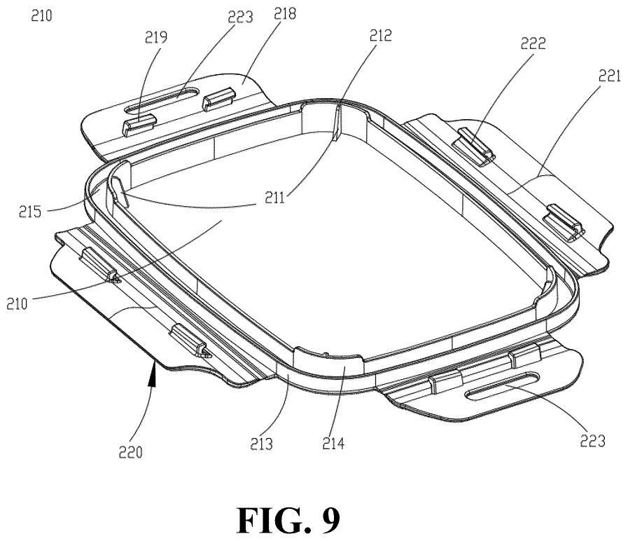

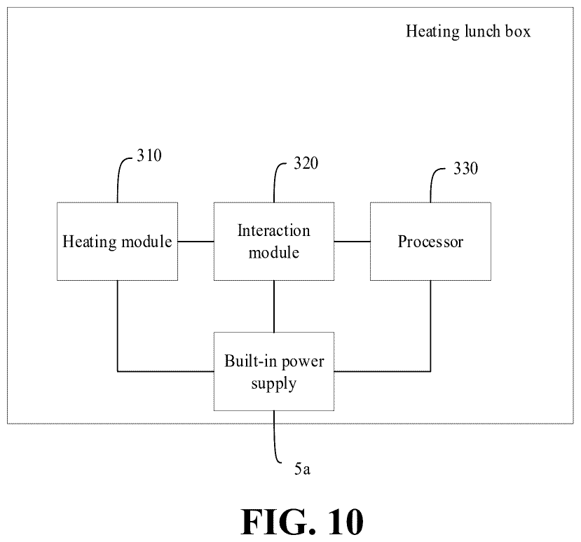

Referring to FIG. 1 to FIG. 10, a heating lunch box is provided in an embodiment of the present invention. The heating lunch box includes a food box 300 for accommodating food, a heating module 310 for heating the food box 300, an interaction module 320, and a processor 330 coupled to the heating module 310 and the interaction module 320. The processor 330 is configured for performing the following operations:
S10: obtaining a power-on instruction, in response to the obtained power-on instruction, controlling the interaction module 320 to display an initial interface, and the initial interface at least including a first time setting control 340;
S20: when a trigger event of the first time setting control 340 is detected, controlling the interaction module 320 to display a time selection interface;
S30: obtaining a set time from the time selection interface;
S40: controlling the interaction module 320 to display a heating interface based on the set time; and
S50: driving the heating module 310 to heat the food box.

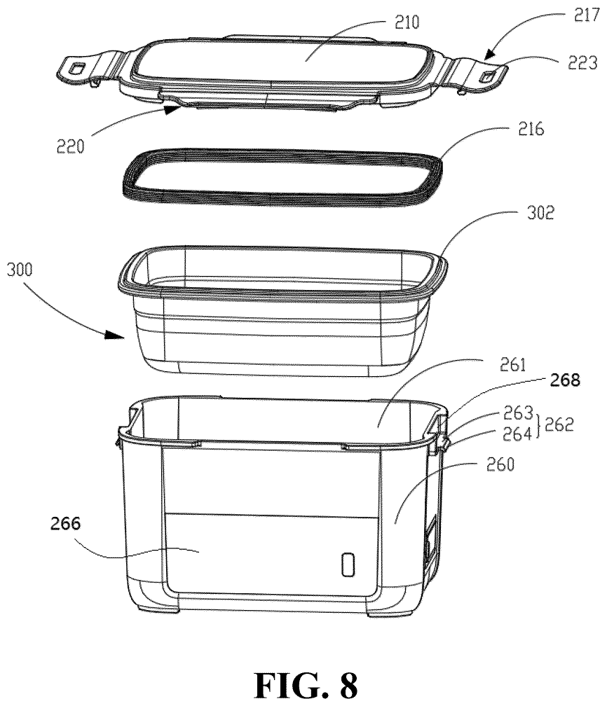

In this embodiment, the heating lunch box is equipped with the interaction module 320, making it convenient for a user to intelligently control the heating lunch box, and improving the intelligence level of the heating lunch box. As an example, the interaction module 320 involved in this embodiment includes a touch screen 266 (see FIG. 8) and a display interface both installed on the heating lunch box. The touch screen 266 is used for the user to operate, forming an instruction or a trigger event based on an operation of the user, controlling the display interface to perform corresponding display, and enhancing the intelligence level of the heating lunch box. The touch screen 266 adopts a capacitive touch technology, can accurately sense a human body touch action, has a multi-point touch function, and can simultaneously identify information such as the position, strength and sliding track of a plurality of touch points, thereby achieving the input of complex instructions such as sliding and selection, and sending the complex instructions to the processor 330. The processor 330 receives the trigger event and performs corresponding processing and control. For example, a touch panel adopts a glass material with high light transmittance, which not only ensures a clear visual effect, but also has good wear resistance and corrosion resistance, and effectively prolongs the service life.

As an example, the interaction module 320 involved in this embodiment includes an interactive mechanical button and a display interface both installed on the heating lunch box. The interactive mechanical button is used for a user to operate, forming an instruction or a trigger event based on an operation of the user, and controlling the display interface to perform corresponding display. Through cooperation of the interactive mechanical button and the display interface, the user is provided with a better service, and user experience satisfaction is improved.

As another example, the interaction module 320 includes a display interface arranged on an intelligent terminal device (such as a smartphone), and/or a display interface arranged on the heating lunch box. The intelligent terminal integrates an application program (APP). A user enters the application program and performs a corresponding operation. The processor 330 forms an instruction or a trigger event based on the operation of the user, and controls the display interface to perform corresponding display, thereby achieving remote control of the heating lunch box.

The display interface uses a high-resolution liquid crystal display (LCD) or an organic light-emitting diode display (OLED), which can present clear and realistic images and text information. Through collaboration with the processor 330 and an image chip, feedback content corresponding to an input instruction of the touch screen can be quickly responded and displayed, including various graphical interfaces, operation prompts, data visualization displays, and the like.

The power-on instruction is used for informing the processor 330 that the heating lunch box has been powered on, and the processor 330 can start working. Specifically, the user clicks a power-on button on the heating lunch box to send the power-on instruction to the processor 330, and the processor 330 obtains the power-on instruction for subsequent processing. The power-on button is a mechanical button on the heating lunch box and is coupled to the processor 330.

The first time setting control 340 is used for setting time. In this embodiment, the first time setting control 340 is used for setting a meal time. Specifically, the user clicks the first time setting control 340 on the initial interface, the processor 330 detects the trigger event of the first time setting control 340, the interaction module 320 is controlled to display the time selection interface, a time selection list is displayed on the time selection interface, and the user selects the meal time from the time selection list and confirms the meal time as the set time. When the processor 330 obtains the set time, the processor 330 controls the interaction module 320 to display the heating interface, and at the same time controls the heating module 310 to heat the food box 300, so that the food is conveniently and quickly heated, and the practicability of the lunch box is improved. In other embodiments, the first time setting control 340 is used for setting the meal time and a heating time. Specifically, the user clicks the first time setting control 340, the processor 330 detects the trigger event of the first time setting control 340, the interaction module 320 is controlled to display the time selection interface, the time selection list is displayed on the time selection interface, and the user selects the meal time from the time selection list and confirms the meal time as the set time. The processor 330 obtains the meal time, calculates a required immediate heating duration based on the meal time, and determines the heating time based on the immediate heating duration and the meal time, that is, subtracting the immediate heating duration from the meal time. Thus, the processor 330 can obtain the meal time and the heating time through the first time setting control 340, and control the interaction module 320 to display, so that the food can be automatically heated when the heating time arrives, and the user can clearly understand the set meal time and heating time, effectively improving the practicality of the lunch box.

In this embodiment, the processor 330 receives the power-on instruction, and controls the interaction module 320 to display the initial interface based on the power-on instruction. The first time setting control 340 of the initial interface reminds the user of the importance of the meal time, allowing the user to operate the first time setting control 340 on the initial interface to generate a trigger event. When the processor 330 receives the trigger event of the first time setting control 340, the interaction module 320 is controlled to display the time selection interface. The user selects time on the selection interface to form the set time, and the processor 330 receives the set time, so that the heating module 310 can be automatically controlled to heat the food box 300, and the user can eat on time without waiting, thereby effectively improving the intelligence of the lunch box, the user experience, and the practicality of the lunch box.

In one embodiment, the heating lunch box can be internally provided with a power supply device, such as a battery. The battery can be a disposable battery, a rechargeable battery, or any other suitable type of battery, thereby providing power to the heating module 310, the interaction module 320, the processor 330, and the like. In this embodiment, when the heating lunch box is internally provided with the power supply device, after powering on, the processor 330 also detects a remaining electric quantity of the power supply device in real time, and the remaining electric quantity is displayed on the interaction module 320. A specific display method is to display through battery level bars and electric quantity color indicators. For example, when the electric quantity is 100%, a full battery bar is displayed, and the electric quantity is displayed in green. When the electric quantity is 67%-99%, three battery bars are shown, and the electric quantity is displayed in green. When the electric quantity is 66%-34%, two battery bars are shown, and the electric quantity is displayed in yellow. When the electric quantity is 0%-33%, one battery bar is displayed, and the electric quantity is displayed in red. Furthermore, the power supply device can be charged by using Type-C charging or solar energy.

In another embodiment, the heating lunch box is powered in a plug-in manner. A power supply device of the heating lunch box is equipped with a plug. By inserting the plug into an external power socket, the connection between the lunch box and the external power supply can be completed, so that the plug-in powering of the lunch box is realized, thereby providing electrical energy for the heating module 310, the interaction module 320, and the processor 330. In this embodiment, the heating module 310 includes, but is not limited to, an electromagnetic heating module, an infrared heating module, an electric heating module, etc., which are not limited here.

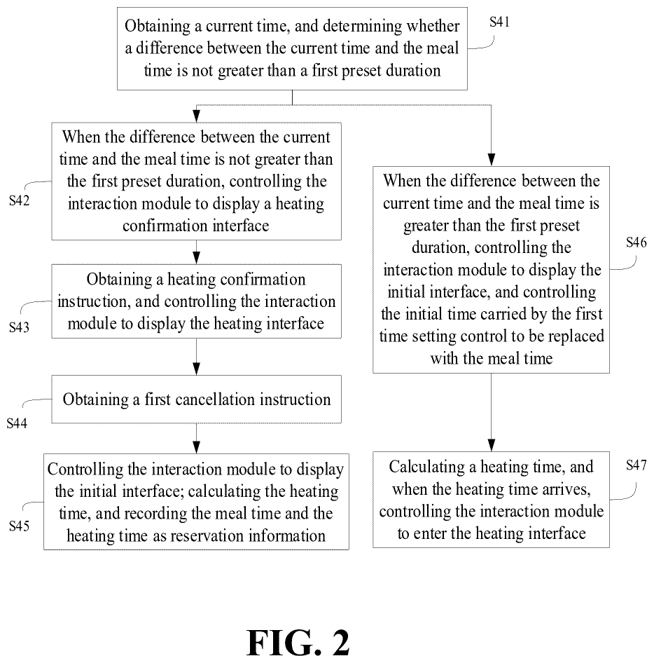

Referring to FIG. 2, in one embodiment, the first time setting control 340 carries a state identifier, and in an initial state, a time corresponding to the state identifier is an initial time.

The step S40 of “controlling the interaction module 320 to display a heating interface based on the set time” includes:
S41: obtaining a current time, and determining whether a difference between the current time and the meal time is not greater than a first preset duration;
S42: when the difference between the current time and the meal time is not greater than the first preset duration, controlling the interaction module 320 to display a heating confirmation interface;
S43: based on the heating confirmation interface, obtaining a heating confirmation instruction, and in response to the obtained heating confirmation instruction, controlling the interaction module 320 to display the heating interface;
S44: based on the heating confirmation interface, obtaining a first cancellation instruction;
S45: based on the first cancellation instruction, controlling the interaction module 320 to display the initial interface; calculating the heating time based on the meal time, and recording the meal time and the heating time as reservation information;
S46: when the difference between the current time and the meal time is greater than the first preset duration, controlling the interaction module 320 to display the initial interface, and controlling the initial time carried by the first time setting control 340 to be replaced with the meal time; and
S47: calculating a heating time based on the meal time, and when the heating time arrives, controlling the interaction module 320 to enter the heating interface.

In this embodiment, the first preset duration is a preset duration, which can be set according to an actual situation. For example, the first preset duration is 1 hour, and of course, the first preset duration can also be 40 minutes. The initial time is a preset time, and during the initial time, the processor 330 will not control the heating module 310 to heat, thereby improving the safety of the heating lunch box. In this embodiment, the immediate heating duration is stored in the processor 330. When the processor 330 obtains the meal time, the heating time is obtained by subtracting the immediate heating duration from the meal time.

The initial state can be a corresponding state when the heating lunch box is not in use, or can be a state after the heating lunch box is restored to its factory settings. In the initial state, the time corresponding to the state identifier is the initial time, indicating that the heating lunch box is not in a heating state and cannot be heated. By setting the state identifier, it is ensured that the heating lunch box does not work in this initial state to avoid accidents. At the same time, the importance of the first time setting control 340 is highlighted, and the user is reminded to operate the first time setting control 340 to heat food. For example, the state identifier is 00:00. Specifically, 00:00 is displayed above the first time setting control 340. In other embodiments, the state identifier can also use highlighted text or icons to highlight the first time setting control 340, etc., which is not limited here. In other embodiments, in a non-initial state, when entering the initial interface, a time corresponding to the state identifier carried by the first time setting control 340 is the meal time, and the user does not need to repeatedly set the meal time.

In this embodiment, the processor 330 compares the current time with the meal time. If the difference between the current time and the meal time is not greater than the first preset duration, it indicates that an interval between the current time and the meal time is short, and immediate heating is required. However, in order to avoid insufficient heating time, the processor 330 controls the interaction module 320 to display the heating confirmation interface. The user can click a confirmation button based on an actual situation. When the processor 330 obtains the heating confirmation instruction, the processor 330 controls the interaction module 320 to display the heating interface, i.e., step S43, to control the heating module 310 to heat. If the heating time is insufficient, the user can click a cancellation button to generate a first cancellation instruction. When the processor 330 receives the first cancellation instruction, the processor 330 controls the interaction module 320 to display the initial interface. Moreover, the processor 330 also calculates the heating time based on the meal time, and records the meal time and the heating time as reservation information, so that the heating lunch box can automatically heat according to the reservation information after subsequent power-on, thereby providing convenience to the user. It is understandable that with the reservation information, in subsequent operations, after powering on, the interaction module 320 enters a power-on interface, and the processor 330 queries the reservation information and compares the meal time of the reservation information with a power-on time. If the power-on time is after the heating time and before the meal time, the processor 330 controls the interaction module 320 to display the heating confirmation interface, allowing the user to further select a corresponding operation. When the difference between the current time and the meal time is greater than the first preset duration, it indicates that the interval between the current time and the meal time is long. If heating is started immediately, subsequent heat preservation may be required, which wastes power. Therefore, the processor 330 controls the interaction interface to jump to the initial interface, and replaces the initial time on the initial interface with the meal time, allowing the user to clearly understand that the setting is successful. When the heating time arrives, the processor 330 controls the interaction module 320 to display the heating interface, achieving a user-friendly setup and saving power.

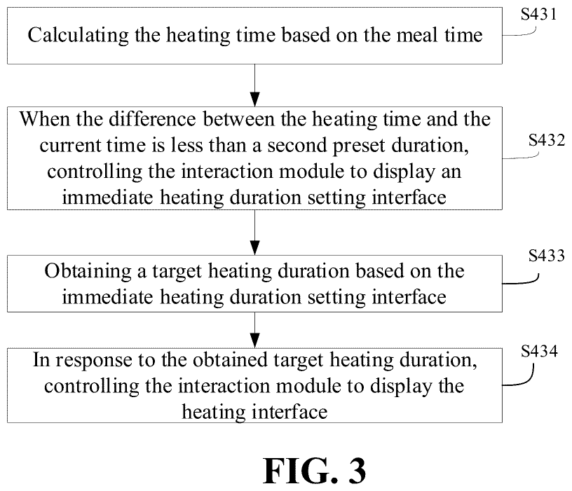

Referring to FIG. 3, in one embodiment, in step S42, the difference between the current time and the meal time is not greater than the first preset duration, so that the immediate heating duration may be insufficient. At this time, if the user still wants to eat, the step S43 of “based on the heating confirmation interface, obtaining a heating confirmation instruction, and in response to the obtained heating confirmation instruction, controlling the interaction module 320 to display the heating interface” includes:
S431: calculating the heating time based on the meal time;
S432: when the difference between the heating time and the current time is less than a second preset duration, controlling the interaction module 320 to display an immediate heating duration setting interface;
S433: obtaining a target heating duration based on the immediate heating duration setting interface; and
S434: in response to the obtained target heating duration, controlling the interaction module 320 to display the heating interface.

In this embodiment, the processor 330 calculates the heating time based on the meal time. When the difference between the heating time and the current time is less than the second preset duration, where the second preset duration equals a preset immediate heating duration, to avoid insufficient heating time, the interaction module 320 is controlled to display the immediate heating duration setting interface. The user operates on the immediate heating duration setting interface to generate the target heating duration required by the user. When the processor 330 receives the target heating duration, the processor 330 controls the interaction module 320 to display the heating interface and controls the heating module 310 to heat, thereby ensuring sufficient heating duration and further improving the practicality of the heating lunch box. It should be noted that the processor 330 stores the immediate heating duration. After obtaining the meal time, the processor 330 calculates the heating time using the immediate heating duration. The user can modify the immediate heating duration according to the user's own need.

As an embodiment, the immediate heating duration setting interface involved in the step S433 carries a control progress bar. The control progress bar carries a lower limit heating duration and an upper limit heating duration. A sliding displacement of the control progress bar is detected to obtain the target heating duration, and the target heating duration is between the lower limit heating duration and the upper limit heating duration. The user drags the progress bar on the interaction module 320 to select the target heating duration. The processor 330 detects the sliding displacement of the control progress bar, determines the immediate heating duration corresponding to the sliding displacement as the target heating duration, and control the heating module 310 to heat the food box 300 according to the target heating duration. The lower limit heating duration is the shortest heating duration, and the upper limit heating duration is the longest heating duration. By setting the lower limit heating duration and the upper limit heating duration, it is convenient for the user to understand an appropriate immediate heating duration and choose from it, so as to ensure that the food tastes good after heating, and the practicability of the heating lunch box is high.

As an embodiment, the heating lunch box further includes a reminder component coupled to the processor 330. When controlling the heating module 310 to heat the food box 300, the processor 330 obtains a real-time heating temperature, controls the heating interface to display the real-time heating temperature, and controls the reminder component to generate a heating reminder signal. The reminder component is a signal light component, and the heating reminder signal is that a light is always on.

In this embodiment, the heating lunch box is also equipped with a temperature sensor coupled to the processor 330. The processor 330 controls the heating module 310 to start heating. The heating module 310 is a heating panel, and the temperature sensor is installed at a bottom portion of the heating panel to detect a real-time heating temperature of the heating panel and send the real-time heating temperature to the processor 330. The processor 330 receives the real-time heating temperature and controls the interaction module 320 to display the real-time heating temperature on the heating interface. At the same time, the reminder component is controlled to generate the heating reminder signal, so that the user can intuitively perceive a working state of the heating lunch box. In this embodiment, the reminder component is a signal light component, and the processor 330 controls the signal light component to generate an always-on light signal. Preferably, the signal light component is a red light, and the processor 330 controls the red light to be always on, which can provide a more noticeable reminder to the user.

As an embodiment, after a duration of controlling the heating module 310 to heat the food box 300 is greater than a third preset duration, the interaction module 320 is controlled to enter a screen-off state. In this embodiment, the third preset duration can be 30 seconds. After the heating interface of the interaction module 320 is displayed for 30 seconds, an interface of the interaction module 320 turns off. This further saves power.

Referring to FIG. 1, in one embodiment, after the step S40 of “controlling the interaction module 320 to display a heating interface”, the processor 330 is configured for performing the following operations:
S60: obtaining a second cancellation instruction based on the heating interface;
S70: in response to the obtained second cancellation instruction, controlling the interaction module 320 to display a heating canceling pop-up window;
S80: obtaining a cancellation confirming instruction based on the heating canceling pop-up window;
S90: in response to the obtained cancellation confirming instruction, controlling the interaction module 320 to display the initial interface; or,
S100: after the operation of “controlling the interaction module 320 to display a heating canceling pop-up window”, obtaining a power-off instruction, and in response to the obtained power-off instruction, controlling the heating lunch box to be powered off.

In this embodiment, after the interaction module 320 displays the heating interface, if the user temporarily does not want to heat the food, the heating interface is equipped with a return button, the user clicks the return button, and the processor 330 receives the second cancellation instruction. In response to the obtained second cancellation instruction, the interaction module 320 is controlled to display the heating canceling pop-up window, allowing the user to confirm whether to further cancel the heating, thereby avoiding an error operation. The user clicks the cancellation button on the heating canceling pop-up window to generate the cancellation confirming instruction, i.e., the step S80. The processor 330 receives the cancellation confirming instruction and controls the interaction module 320 to display the initial interface, allowing the user to perform subsequent operations on the initial interface. Of course, after the interaction module 320 displays the heating canceling pop-up window, the user can also press a power-off button to send the power-off instruction to the processor 330. After the processor 330 receives the power-off instruction, the processor 330 controls the heating lunch box to be powered off. In this embodiment, specifically, the processor 330 obtains a first power-off signal formed by the power-off button being pressed for a first pressing duration, and obtains a second power-off signal formed by the power-off button being pressed for a second pressing duration. When the first power-off signal and the second power-off signal are received, the power-off instruction is confirmed to be received. The first pressing duration is not equal to the second pressing duration. In this embodiment, the first pressing duration can be greater than the second pressing duration, or vice versa, which is not limited here. When the processor 330 detects that the user presses the power-off button twice, and the duration of the two presses is not equal, the user can be prevented from mistakenly touching the power-off button.

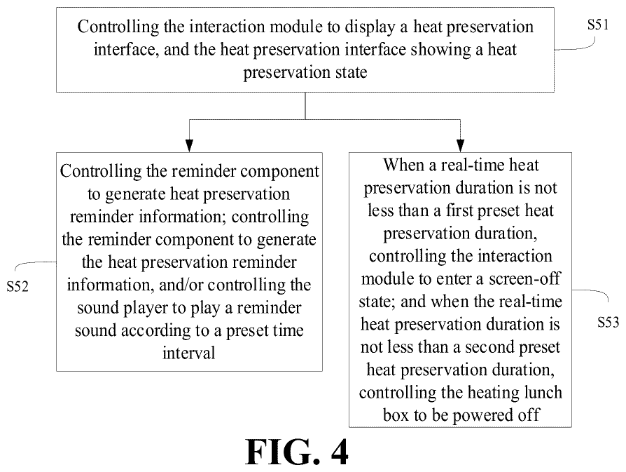

Referring to FIG. 4, as an embodiment, the heating lunch box further includes a reminder component coupled to the processor 330.

After the step S50, that is, after controlling the heating module 310 to heat the food box 300, the processor 330 is configured for performing the following operations:
S51: when heating is detected to be completed, controlling the interaction module 320 to display a heat preservation interface, and the heat preservation interface showing a heat preservation state; and
S52: controlling the reminder component to generate heat preservation reminder information, wherein the reminder component includes at least one of a signal light component and a sound player; controlling the reminder component to generate the heat preservation reminder information, including controlling the signal light component to generate a breathing signal, and/or controlling the sound player to play a reminder sound according to a preset time interval.

In this embodiment, after heating is completed, i.e., after the immediate heating duration is completed, the processor 330 controls the interaction module 320 to display the heat preservation interface. The heat preservation interface can display a text identifier of being in heat preservation, allowing the user to intuitively know that the food heating is complete. At the same time, the reminder component is controlled to generate the heat preservation reminder information. The reminder component is at least one of the signal light component or the sound player. When the signal light component is controlled to generate the breathing signal, in this embodiment, the signal light component is a red light, and the breathing signal is that the red light gradually brightens for one second and then gradually dims for one second. The sound player is controlled to play the reminder sound according to the preset time interval. Specifically, a “ding” sound can be produced, and the reminder is repeated every preset time interval.

Referring to FIG. 4, as an embodiment, after the step S51, i.e., after “controlling the interaction module 320 to display a heat preservation interface, and the heat preservation interface showing a heat preservation state”, the processor 330 is configured for performing the following operations:
S53: detecting a real-time heat preservation duration, and when the real-time heat preservation duration is not less than a first preset heat preservation duration, controlling the interaction module 320 to enter a screen-off state; and when the real-time heat preservation duration is not less than a second preset heat preservation duration, controlling the heating lunch box to be powered off. The first preset heat preservation duration is less than the second preset heat preservation duration.

In this embodiment, the processor 330 also records the real-time heat preservation duration of the heat preservation interface. When the real-time heat preservation duration is greater than the first preset heat preservation duration, the interaction module 320 is controlled to enter the screen-off state. When the real-time heat preservation duration is not less than the second preset heat preservation duration, the heating lunch box is controlled to be powered off, thereby avoiding waste of electric energy, and also protecting the power supply of the battery.

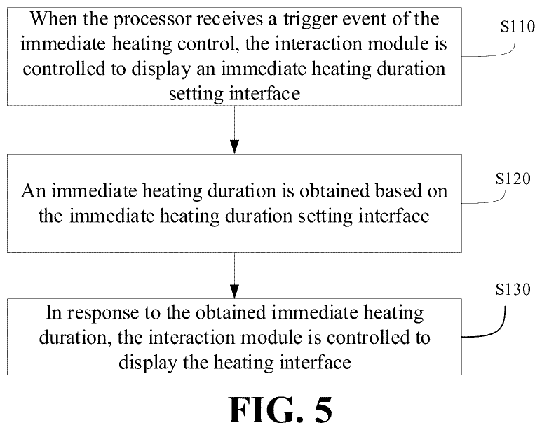

Referring to FIG. 5, as an embodiment, the initial interface also includes an immediate heating control;
S110: when the processor 330 receives a trigger event of the immediate heating control, the interaction module 320 is controlled to display an immediate heating duration setting interface;
S120: an immediate heating duration is obtained based on the immediate heating duration setting interface; and
S130: in response to the obtained immediate heating duration, the interaction module 320 is controlled to display the heating interface.

In this embodiment, the user can also directly control the heating lunch box to heat the food through the immediate heating control of the initial interface. Specifically, when the user clicks the immediate heating control of the initial interface, the processor 330 receives the trigger event of the immediate heating control and controls the interaction module 320 to display the immediate heating duration setting interface. The immediate heating duration setting interface is provided with an immediate heating duration progress bar. The immediate heating duration progress bar includes a lower limit heating duration and an upper limit heating duration. The user can drag the immediate heating duration progress bar to select an immediate heating duration. The processor 330 receives a sliding displacement of the immediate heating duration progress bar to confirm the immediate heating duration. When the immediate heating duration is reached, the interaction module 320 is controlled to display the heating interface, and the heating module 310 is controlled to heat according to the immediate heating duration. In this embodiment, when the interaction module 320 enters the screen-off state, the interaction interface is locked. It is necessary to press the power-on/power-off button briefly to light up the screen, and then swipe the screen to unlock before the user can perform the operation again.

As an embodiment, the initial interface also includes a setting control.

When a trigger event of the setting control is received, the interaction module 320 is controlled to display a setting interface. The setting interface includes at least one of a reservation mode control, a current time setting control, a temperature adjustment control, a unit adjustment control, a language adjustment control, a sound adjustment control, and a factory setting restoration control.

In this embodiment, when the user clicks on the setting control of the initial interface, the processor 330 receives the trigger event of the setting control and controls the interaction module 320 to display the setting interface. The user can click on at least one of the reservation mode control, the current time setting control, the temperature adjustment control, the unit adjustment control, the language adjustment control, the sound adjustment control, and the factory setting restoration control on the setting interface for setting, so that the heating lunch box can better provide personalized services for the user.

Specifically, when a trigger event of the reservation mode control is received, the processor 330 controls the interaction module 320 to display a reservation mode interface. A reservation heating duration is obtained based on the reservation mode interface. The reservation mode interface includes a lower limit heating duration and an upper limit heating duration. The reservation heating duration is between the lower limit heating duration and the upper limit heating duration. The user can select the reservation heating duration from the reservation mode interface in advance, and the reservation heating duration is between the lower limit heating duration and the upper limit heating duration. The heating can be performed at an appropriate heating duration to ensure a better taste of the food.

When a trigger event of the current time setting control is received, the processor 330 controls the interaction module 320 to display a time selection interface. The time selection interface displays a time selection list, and a current time is obtained based on the time selection list. In this embodiment, the user can select the current time through the time selection list to ensure the subsequent accuracy of time of the heating lunch box.

When a trigger event of the temperature adjustment control is received, the interaction module 320 is controlled to display a temperature adjustment interface. The temperature adjustment interface includes a temperature progress bar. The temperature progress bar includes an upper limit heating temperature and a lower limit heating temperature. A heating parameter is obtained based on the temperature progress bar, a target heating temperature is obtained based on the heating parameter, the heating module 310 is controlled to heat according to the target heating temperature, and the target heating temperature is between the upper limit heating temperature and the lower limit heating temperature. In this embodiment, the user can select the heating temperature through the temperature progress bar on the temperature adjustment interface to ensure that the user can choose different heating temperatures according to the food, thereby ensuring better food taste.

When a trigger event of the unit adjustment control is received, the interaction module 320 is controlled to display a unit system switching interface. The unit system switching interface includes a temperature unit switching control and a time unit switching control. When the temperature unit switching control is triggered, a temperature unit of the interaction module 320 is controlled to be switched. When the time unit switching control is triggered, a time unit of the interaction module 320 is controlled to be switched. In this embodiment, the temperature unit switching control facilitates the user to switch between a Celsius unit and a Fahrenheit unit of temperature. The time unit switching control facilitates the user to switch between a 12-hour time system and a 24-hour time system. Therefore, usage needs of different users are met, and the applicable population of the heating lunch box is increased.

When a trigger event of the language adjustment control is received, the interaction module 320 is controlled to display a language selection list. Based on the language selection list, a target language is obtained, and a text of the interaction module 320 is controlled to be displayed according to the target language. In this embodiment, the user selects the target language from the language selection list and clicks a restart confirming button. When the processor 330 receives the target language and a restart confirming signal, the heating lunch box restarts. After the restart, all text in the interaction module 320 is controlled to be displayed in the target language.

When a trigger event of the sound adjustment control is received, the interaction module 320 is controlled to display a sound adjustment interface. The sound adjustment interface includes a sound adjustment progress bar. A volume adjustment parameter is obtained based on the sound adjustment progress bar. A volume corresponding to the volume adjustment parameter is determined as a target volume. The sound player and the interaction module 320 are controlled to play according to the target volume. In this embodiment, the user drags the progress bar on the interactive interface, and the volume adjustment parameter is formed in the process of dragging the progress bar and is sent to a controller, so that the controller determines the final target volume.

When a trigger event of the factory setting restoration control is received, the interaction module 320 is controlled to display a factory setting restoration interface, a factory setting restoration instruction is obtained based on the factory setting restoration interface, and the interaction module 320 is restored to a factory setting.

As an embodiment, in response to a sliding displacement of the sound adjustment progress bar, the interaction module 320 is controlled to play a corresponding volume. When the sliding displacement of the sound adjustment progress bar is zero, a sound icon of the interaction module 320 is controlled to be a mute icon. When the sliding displacement of the sound adjustment progress bar is not zero, the sound icon of the interaction module 320 is controlled to be a sound wave icon. In this embodiment, a volume setting of the heating lunch box can be effectively determined for the user through the mute icon and the sound wave icon. In this embodiment, the user drags the sound adjustment progress bar, and at the same time the processor 330 controls the interaction module 320 to play a corresponding volume, making it easier for the user to perceive the volume and select a desired volume.

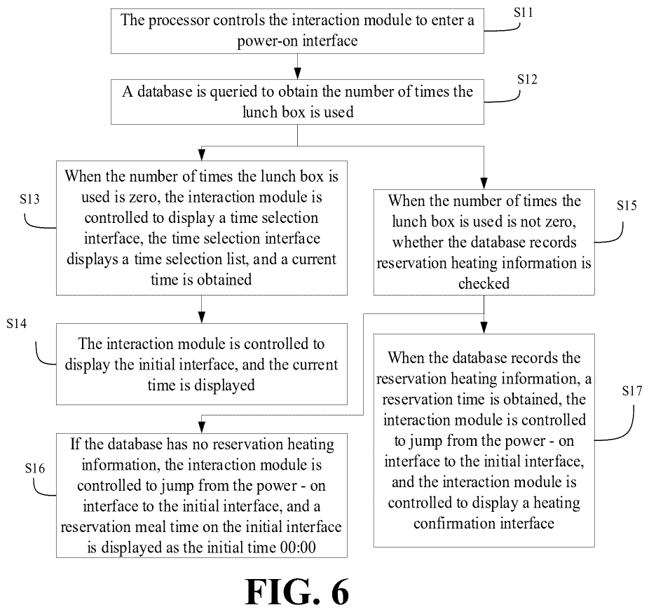

Referring to FIG. 6, as an embodiment, after “obtaining a power-on instruction” in the step S10, and before “in response to the obtained power-on instruction, controlling the interaction module 320 to display an initial interface” in the step S10,
S11: the processor 330 controls the interaction module 320 to enter a power-on interface;
S12: a database is queried to obtain the number of times the lunch box is used;
S13: when the number of times the lunch box is used is zero, the interaction module 320 is controlled to display a time selection interface, the time selection interface displays a time selection list, and a current time is obtained based on the time selection list;
S14: when the current time is obtained, the interaction module 320 is controlled to display the initial interface, and the current time is displayed.
S15: when the number of times the lunch box is used is not zero, whether the database records reservation heating information is checked;
S16: if the database has no reservation heating information, the interaction module 320 is controlled to jump from the power-on interface to the initial interface, and a reservation meal time on the initial interface is displayed as the initial time 00:00; and
S17: when the database records the reservation heating information, a reservation time is obtained, the interaction module is controlled to jump from the power-on interface to the initial interface, the reservation meal time on the initial interface is displayed as a reservation meal time set by a user, and the interaction module is controlled to display a heating confirmation interface based on a reservation heating time.

In this embodiment, after the processor 330 obtains the power-on instruction, if the number of times the lunch box is used is zero, the processor 330 controls the interaction module 320 to display the time selection interface for the user to select the current time. When the number of times the lunch box is used is not zero but there is no reservation information, the interaction module 320 is controlled to display the initial interface, making it convenient for the user to select the meal time and other operations. When the number of times the lunch box is used is not zero, but there is reservation information, the heating time is obtained from the reservation time, and the interaction module 320 is controlled to display the heating confirmation interface for quick heating.

As an embodiment, step S10, that is, obtaining a power-on instruction, includes: obtaining a first power-on signal and a second power-on signal, and based on the first power-on signal and the second power-on signal, determining that the power-on instruction has been obtained.

In this embodiment, the processor 330 only confirms receipt of the power-on instruction upon receiving the first power-on signal and the second power-on signal, thereby avoiding the user from accidentally touching the heating lunch box and performing an error operation.

Specifically, the heating lunch box is equipped with a power-on button coupled to the processor 330. The processor 330 obtains the first power-on signal formed by the power-on button being pressed for the first pressing duration, and obtains the second power-on signal formed by the power-on button being pressed for the second pressing duration. The first pressing duration and the second pressing duration are not equal.

In this embodiment, the first pressing duration can be greater than the second pressing duration, and vice versa, which is not limited here. When the processor 330 detects that the user has pressed the power-on button twice and the duration of the two presses is not equal, the user can be prevented from accidentally touching the power-on button. In this embodiment, the power-on button and the power-off button can be an identical mechanical button.

In one embodiment, the processor 330 is also used for monitoring a screen-on duration of the interaction module 320. When the screen-on duration is greater than a third preset duration and no instruction is received, the interaction module 320 is controlled to enter a screen-off state. When the interaction module 320 displays an interface that can be operated by the user, the processor 330 monitors the screen-on duration of the interaction module 320 in real time. When the screen-on duration is greater than the third preset duration and no instruction is received, the interaction module 320 is controlled to enter the screen-off state, which is beneficial to saving power.

The sequence numbers of the foregoing embodiments of the present invention are merely for description, and do not represent the advantages and disadvantages of the embodiments. In addition, although a logical order is shown in the flow diagrams, in some cases, the steps shown or described may be performed in an order different from that described herein.

In one embodiment, the processor 330 can be one or more, and the processor 330 is configured for performing the above heating steps. The processor 330 can be a Central Processing Unit (CPU), other general-purpose processors, a Digital Signal Processor (DSP), etc. The general-purpose processor can be a microprocessor, or the processor 330 can also be any conventional processor or the like.

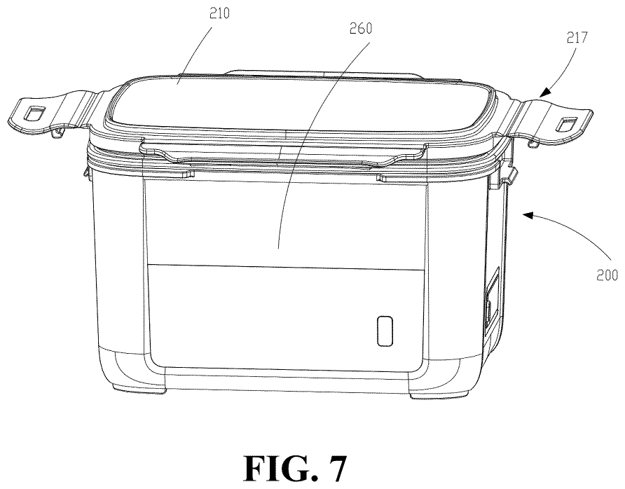

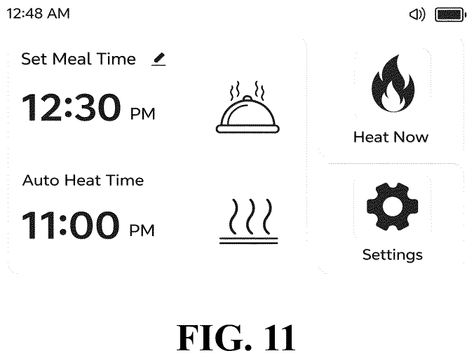

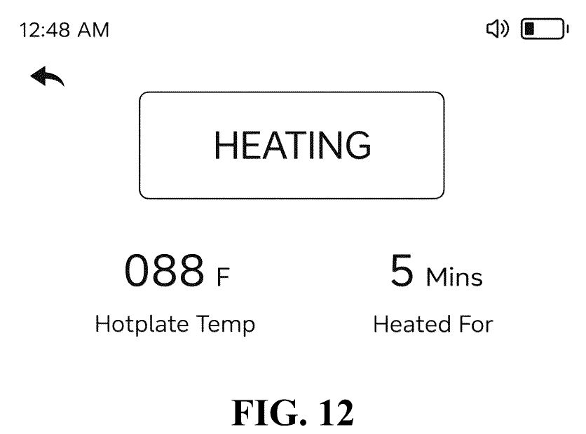

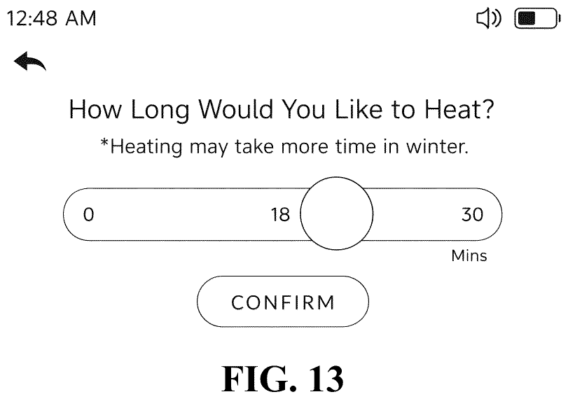

Referring to FIGS. 7-9, as an embodiment, the heating lunch box further includes a shell 200. The shell 200 includes an upper cover 210 and a base 260. A built-in power supply, the heating module 310, and the processor 330 may be mounted in a lower portion of the base 260. The heating lunch box further includes a touch display screen 266 arranged in the base 260 and exposed at a front side of the base 260. The touch display screen 266 is configured to display a heating setting interface for receiving at least one heating setting instruction input by users and display a heating interface including heating time related information, such as shown by FIGS. 11-13.

An upper portion of the base 260 is provided with an accommodating cavity 261 for accommodating a food box 300. The upper cover 210 is used for covering the base 260 and the food box 300. The upper cover 210 is equipped with a positioning component 211. The positioning component 211 is used for limiting a position of the food box 300, so that the food box 300 is placed on the upper cover 210. The positioning component 211 includes at least two positioning members 212 formed by an inner wall of the upper cover 210 extending along a direction of the base 260. At least two of the positioning members 212 are symmetrically arranged. At least two of the positioning members 212 are used for abutting against an outer wall of the food box 300. In this embodiment, a periphery of the upper cover 210 is equipped with an outer sealing ring 213 extending upwards and an inner sealing ring 214 opposite to the outer sealing ring 213. A sealing groove 215 is formed between the outer sealing ring 213 and the inner sealing ring 214. The sealing groove 215 is used for receiving a sealing member 216. The inner sealing ring 214 and a surface of the upper cover 210 form a groove. The positioning member 212 is installed on the inner sealing ring 214 and abuts against the outer wall of the food box 300, so that the upper cover 210 can be used as a tray for the food box 300 for the placement of the food box 300, and the positioning member 212 abuts against the food box 300 to prevent the food box 300 from moving. Furthermore, the positioning member 212 is arranged in a trapezoidal shape.

As an embodiment, the base 260 is provided with a clasp member 262. The upper cover 210 comprises a pair of first fastening component 217. An opening edge of the food box 300 extends outward to form a convex edge 302. The convex edge 302 cooperates with the first fastening component 217 to fasten the food box 300 and the upper cover 210. The clasp member 262 cooperates with the pair of first fastening components 217 to fasten the base 260 and the upper cover 210.

The first fastening component 217 includes a first fastening plate 218 and a first fastening member 219. The first fastening plate 218 is foldable relative to the upper cover 210. The first fastening member 219 is arranged on the first fastening plate 218. The first fastening member 219 is L-shaped. The convex edge 302 is configured to be fastened with the first fastening member 219, so that the food box 300 and the upper cover 210 are fastened.

The first fastening component 217 includes a through hole 223 defined in the first fastening plate 218. The clasp member 262 includes a first flange 263 arranged on an outer wall of the base 260 and a barb portion 264 connected to a free end of the first flange 263. The barb portion 264 is used for penetrating the through hole 223, so that the base 260 and the upper cover 210 are fastened. As illustrated by FIG. 8, a recess groove 268 is defined in an outside of the base 260. When the first fastening component 217 is securely engaged with the clasp member 262, the first fastening component 217 is accommodated in the recess groove 268. The clasp member 262 is located at a bottom of the recess groove 268, and extends outwardly from the bottom in a direction away from the recess groove 268.

In this embodiment, a total number of the clasp member 262 is two, and a total number of the first fastening components 217 is two. The two clasp members 262 are symmetrically arranged on both sides of the base 260. The two first fastening components 217 are symmetrically arranged on both sides of the upper cover 210. The upper cover 210 is rectangular in shape. Therefore, the third fastening component and the first fastening component 217 are arranged on adjacent sides of the upper cover 210, and the first fastening component 217 and the clasp member 262 are correspondingly arranged to ensure covering. The through hole 223 and the first fastening member 219 are both position on the first fastening plate 218. The through hole 223 cooperates with the clasp member 262 to fasten the upper cover 210 and the base 260, and the first fastening member 219 cooperates with the convex edge 302 to fasten the upper cover 210 and the food box 300, which is conducive to tight fastening and can effectively avoid a problem of liquid leakage of the food box 300. During covering, the convex edge 302 of the food box 300 is placed on the base 260, and liquid will not enter the accommodating cavity 261. Compared with existing lunch boxes, the structure is simpler and more practical.

Furthermore, the upper cover 210 is equipped with a second fastening component 220. The third fastening component cooperates with the second fastening component 220, so that the food box 300 and the upper cover 210 are fastened. The second fastening component 220 includes a second fastening plate 221 and a second fastening member 222. The second fastening plate 221 is foldable relative to the upper cover 210. The second fastening member 222 is arranged on the second fastening plate 221. A cross-section of the second fastening member 222 is U-shaped to cooperate with the convex edge 302, so that the food box 300 and the upper cover 210 are fastened. By providing the second fastening component 220, it can be ensured that the upper cover 210 and the food box 300 are fastened more tightly.

Further details of construction of the heating lunch box of the above embodiments will be described in the following.

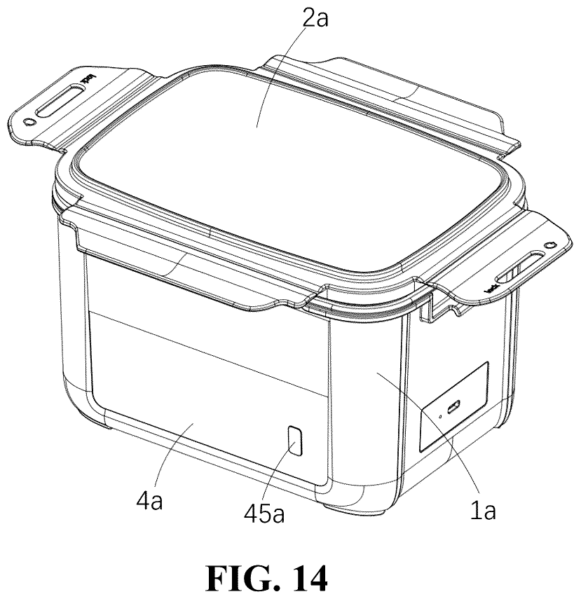

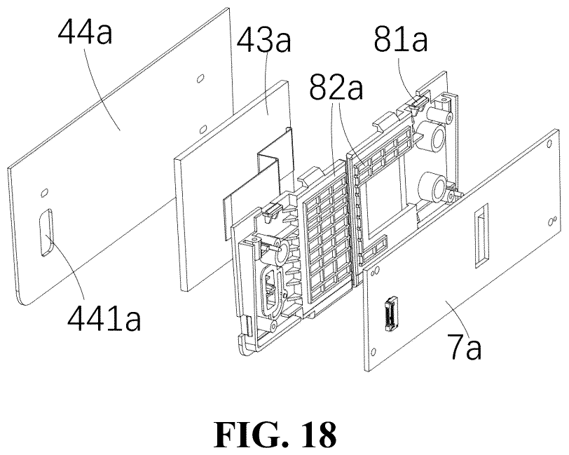

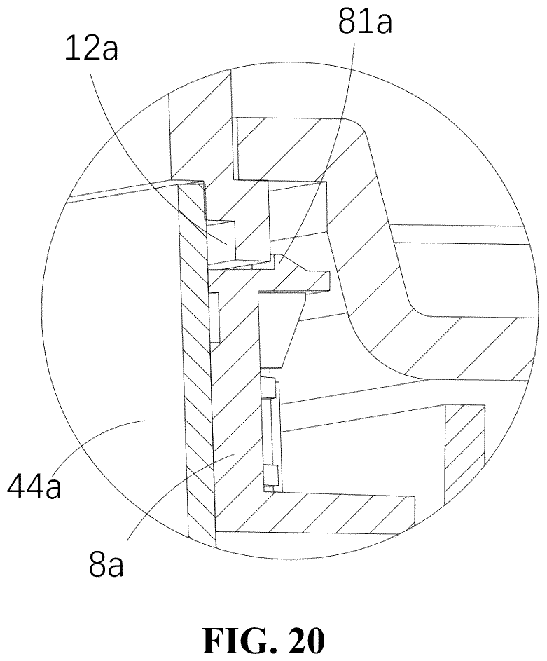

As shown in FIGS. 14 to 23, the present disclosure provides a heating lunch box including a main body 1a, a container box 2a, a heating module 3a, and a touch screen module 4a. A heating chamber 100a may be formed in the main body 1a. The container box 2a may be detachably connected to the heating chamber 100a. The container box 2a may define a containing chamber 200a therein, for containing food. The heating module 3a may be mounted inside the main body 1a and configured to heat the heating chamber 100a and the container box 2a inside the heating chamber 100a. The touch screen module 4a may be mounted on the main body 1a, and a touch-sensitive portion of the touch screen module 4a may be exposed out of the main body 1a, enabling a user to perform operations to control an operating status of the heating module 3a to display information, such as a temperature and a heating duration.

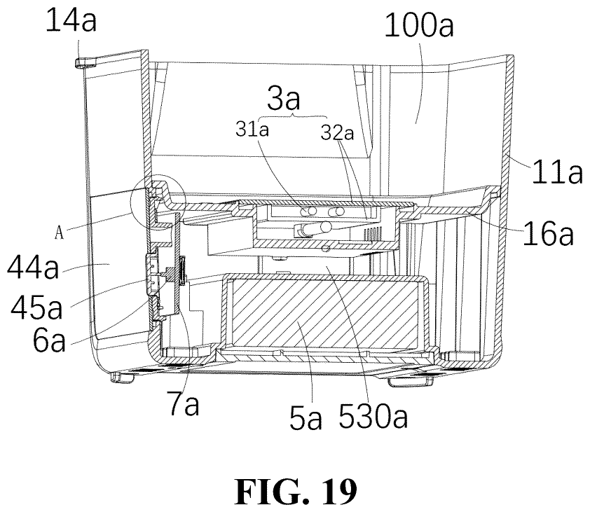

As shown in FIG. 19, a control board 7a, a built-in power supply 5a, a power switch 6a, and a charging mechanism for recharging the built-in power supply 5a may be mounted in the main body 1a. The built-in power supply 5a is arranged inside the main body 1a, such that the user may carry the heating lunch box for outdoor usage. In this way, the food may be heated even in environments where no external power source is provided.

The power switch 6a may be configured to connect or disconnect electrical connection between the control board 7a and the built-in power supply 5a. The touch screen module 4a may further include a switch button 45a. The switch button 45a may be movable. By pressing the switch button 45a, the user may activate the power switch 6a to turn on or turn off the heating lunch box.

Therefore, the user may use the container box 2a in the heating lunch box to receive the food and control the operating status of the heating module 3a via the touch screen module 4a. In this way, the user may customizingly heat the food received in the container box 2a. For example, the user may preset a time point at which the user may eat the food and may preset a heating time length and a heating temperature. The heating lunch box may automatically initiate heating based on the presetting made by the user. The heating may be completed when a specified time is reached, and the user may immediately eat the food without waiting for any additional time length for food heating.

Due to arrangement of the touch screen module 4a, the user may perform controlling via the touch screen, such that human-machine interaction may be achieved more conveniently and efficiently. Furthermore, the number of physical buttons may be reduced, and therefore, durability of the heating lunch box may be improved.

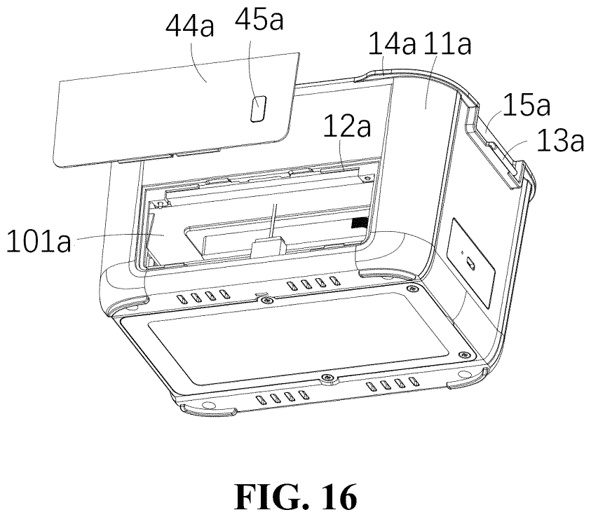

As shown in FIGS. 16 to 19, in some embodiments, a mounting port 101a may be formed on the main body 1a, and the touch screen module 4a may be elastically snap-fitted at the mounting port 101a. In this way, mounting and maintenance may be facilitated.

Specifically, the main body 1a may include a shell 11a and a first snap-fit structure 12a. The mounting port 101a may be defined in the shell 11a. The first snap-fit structure 12a may be disposed at an edge of the mounting port 101a. The heating lunch box may further include a mounting assembly 8a and a second snap-fit structure 81a formed on the mounting assembly 8a. The touch screen module 4a may be fixedly mounted on the mounting assembly 8a. The first snap-fit structure 12a and the second snap-fit structure 81a may be elastically snap-fitted to each other, enabling the mounting assembly 8a to be mounted on or detached off from the shell 11a. In addition, a plurality of first snap-fit structures 12a and a plurality of second snap-fit structures 81a corresponding to the plurality of first snap-fit structures 12a may be arranged. The mounting assembly 8a may serve as a stabilizing structure for the control board 7a and the touch display screen 43a and may include a plurality of frames 82a. The control board 7a may be secured to the plurality of frames 82a via screws. The touch display screen may be fixed to the plurality of frames 82a via adhesive bonding. The second snap-fit structure 81a may be integrally formed with the plurality of frames 82a.

The touch display screen 43a may be at least partially exposed through the mounting port 101a to enable the user to perform operations thereon. The touch display screen 43a may be protruding with respect to the mounting port 101a, or may be flush with the mounting port 101a, or may be recessed with respect to the mounting port 101a. The touch display screen 43a and the heating module 3a may be electrically connected to the control board 7a, enabling the user to adjust the operating status of the heating module 3a by touching the touch display screen 43a. The control board 7a may be a printed circuit board PCBA. The touch display screen 43a may be a conventional touch screen. The first snap-fit structure 12a may be a protruding tab formed at the edge of the mounting port 101a. The second snap-fit structure 81a may be a snap tab. The snap tab may extend over the protruding tab to further extend into the mounting port 101a to abut an inner side of the protruding tab.

For the touch screen module 4a, in some embodiments, the snap-fit structure may be omitted from the mounting assembly 8a, and the mounting assembly 8a may be secured to the shell 11a via screws.

For the touch screen module 4a, in some embodiments, the mounting assembly 8a and the touch screen module 4a may not be arranged cooperatively to each other, and instead, the touch screen module 4a may be directly adhered and fixed at the mounting port 101a.

In the above embodiments, the touch screen module 4a may further include an outer touch plate 44a. The outer touch plate 44a may be a transparent or partially transparent glass plate. The outer touch plate 44a may cover the mounting port 101a and may be attached to a surface of the touch display screen 43a exposed through the mounting port 101a. In this way, the outer touch plate 44a may protect the surface of the touch display screen 43a. A through opening 441a may be formed in the outer touch plate 44a, and at least part of the switch button 45a may pass through the through opening 441a to be exposed out of the main body 1a.

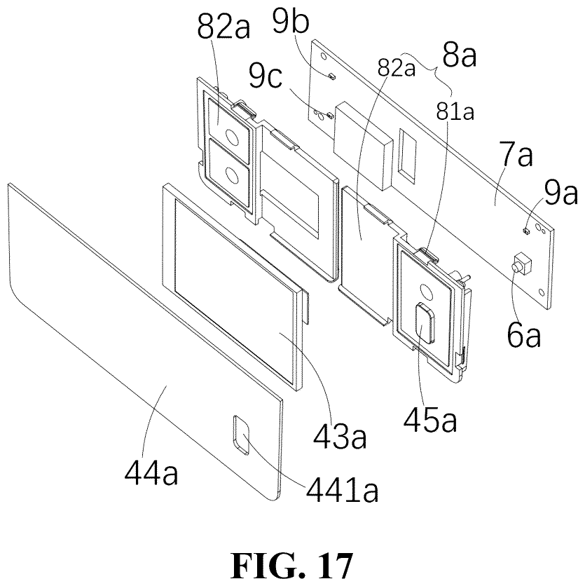

In some embodiments, as shown in FIG. 17, the heating lunch box may further include a power indicator light 9a, a heating indicator light 9b, and a charging indicator light 9c. The power indicator light 9a, the heating indicator light 9b, and the charging indicator light 9c may be mounted on the plurality of frames 82a of the mounting assembly 8a or mounted on the control board 7a; and may be electrically connected to the control board 7a. The mounting assembly 8a may define openings, and each of the power indicator light 9a, the heating indicator light 9b, and the charging indicator light 9c may correspond to a respective one of the openings. Light emitted by each of the power indicator light 9a, the heating indicator light 9b, and the charging indicator light 9c may pass through the respective opening to further pass through the outer touch plate 44a to be visible to the user. The power indicator light 9a may be associated with a power-on/off status of the control board 7a, the heating indicator light 9b may be associated with the operating status of the heating module 3a, and the charging indicator light 9c may be associated with an operating status of the charging mechanism. For example, after pressing the switch button 45a, the power indicator light 9a may illuminate. For example, after the heating module 3a starts operating, the heating indicator light 9b may illuminate. For example, when the charging mechanism connects the built-in power supply 5a to the external power source, the charging indicator light 9c may illuminate.

In some embodiments, as shown in FIG. 19, inside the shell 11a of the main body 1a, a tray 16 may be arranged to serve as a bottom wall of the heating chamber 100a. The heating module 3a may include a heating element 31a and a heat-conducting member 32a. The heating element 31a may be electrically connected to the touch screen module 4a. The heating element 31a may transfer heat to the heat-conducting member 32a. The heat-conducting member 32a may be at least partially exposed from a bottom of heating chamber 100a. The heating element 31a may be a semiconductor heating element, a heating rod, or a PTC heating element, and so on. In the present embodiment, the heating element 31a may be the PTC heating element. The PTC heating element may have self-limiting temperature performance, such that excessive heating may be prevented. The heat-conducting member 32a may be an aluminum plate. The aluminum plate may have a high thermal conductivity. The heating element 31a may be embedded within or attached to the aluminum plate. In addition, the heating module 3a may further include a temperature sensing unit, configured to monitor a temperature of the heat-conducting member 32a.

The aluminum plate may be exposed into the heating chamber 100a from the tray 16 at the bottom of the heating chamber 100a. When the container box 2a is placed in the heating chamber 100a, a bottom of the container box 2a may contact the aluminum plate to enhance a heat transfer efficiency.

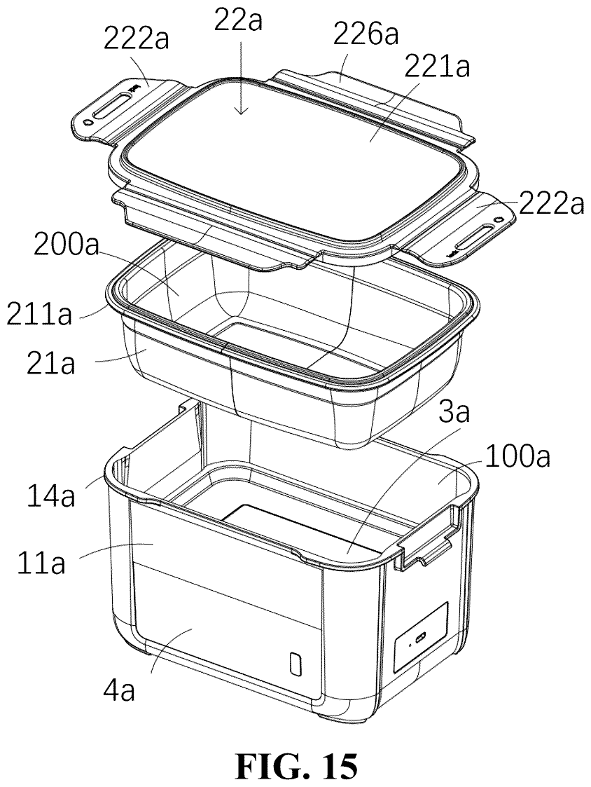

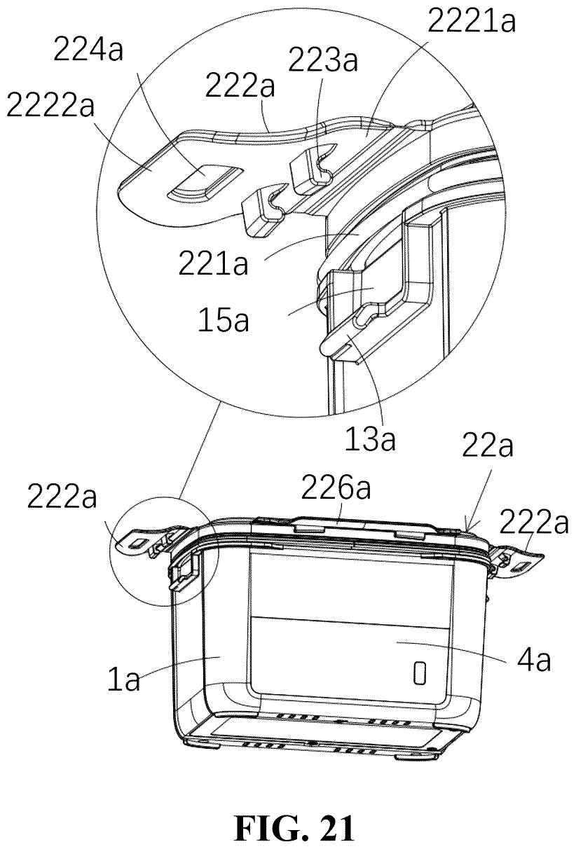

In some embodiments, as shown in FIGS. 15 and 21, the container box 2a may include a box body 21a and a cover body 22a. The containing chamber 200a may be formed inside the box body 21a, and the cover body 22a may cover the containing chamber 200a. The cover body 22a may further elastically snap-fit with the box body 21a and the main body 1a.

Specifically, the box body 21a may be a stainless steel box, which may be highly durable and have excellent thermal conductivity. The cover body 22a may include a covering portion 221a, a first connection plate 222a movable around the covering portion 221a, a second connection plate 226a, and a first latch portion 223a and a second latch portion 224a formed on the first connection plate 222a. The covering portion 221a may be configured to cover the containing chamber 200a. A third latch portion 211a may be protrudingly formed on an outer edge of an opening of the box body 21a. The first latch portion 223a may be elastically latched with the third latch portion 211a. The main body 1a may include the shell 11a and a fourth latch portion 13a formed on an outer side of the shell 11a. The second latch portion 224a may be elastically latched with the fourth latch portion 13a.

After the cover body 22a is detached from the box body, the user may flip over the cover body 22a and may use the flipped cover body 22a to carry the box body 21a thereon.

In addition, the covering portion 221a may be substantially rectangular in shape. For each of two first opposite sides of the covering portion 221a, the first connection plate 222a may be connected to one side. For each of two second opposite sides of the covering portion 221a, the second connection plate 226a may be connected to one side. Each of the first connection plate 222a and the second connection plate 226a may be arranged with a first latch portion 223a to be latched with the third latch portion 211a on the box body 21a, so as to secure the cover body 22a to the box body 21a via latched connection. In addition, each first connection plate 222a may be arranged with a second latch portion 224a to be latched with the fourth latch portion 13a on the main body 1a, so as to secure the container box 2a within the heating chamber 100a of the main body 1a. Correspondingly, each of the box body 21a and the shell 11a may be substantially rectangular in shape. Each of four sides of the box body 21a may be arranged with one third latch portion 211a. For at least two of four sides of the shell 11a, each side may be arranged with one fourth latch portion 13a. Two first connection plates 222a and two second connection plates 226a may be distributed and connected to the four sides of the box body 21a and the four sides of the shell 11a. In this way, connection stability may be improved.

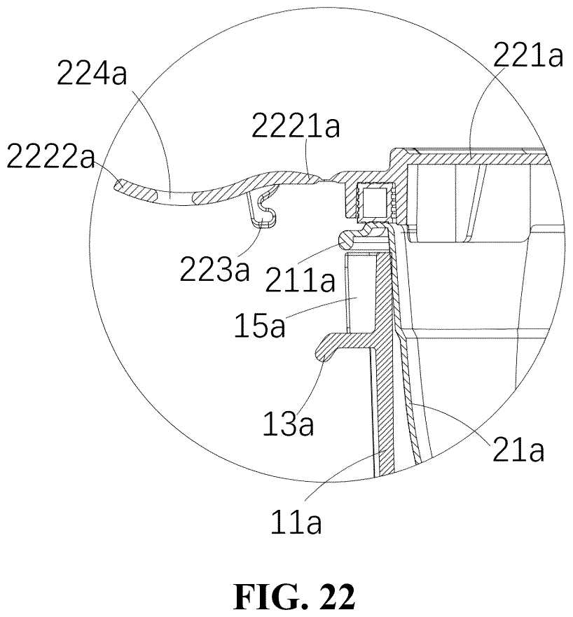

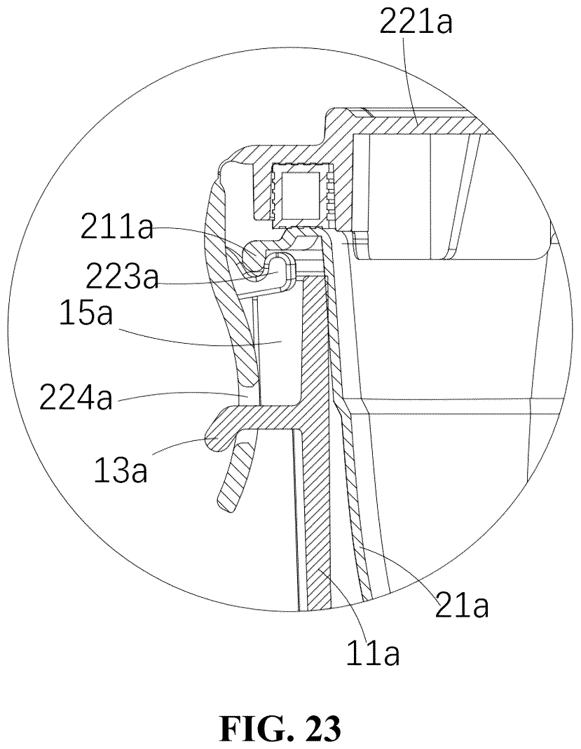

Specifically, as shown in FIGS. 22 and 23, a first end 2221a of the first connection plate 222a may be rotatably connected to the covering portion 221a. A second end 2222a of the first connection plate 222a may be curved away from the shell 11a. The first latch portion 223a may be disposed near or at the first end 2221a. The second latch portion 224a may be disposed near or at the second end 2222a. Specifically, the first latch portion 223a may be a hook, and the second latch portion 224a may be an engagement hole formed in the first connection plate 222a. The third latch portion 211a may be a flange formed at a top edge of the box body 21a, and the fourth latch portion 13a may be an engagement tab. An end of the engagement tab away from the shell 11a may be curved downward. The first latch portion 223a and the fourth latch portion 13a may be deformable to some extent, such that being latched to each other or releasing latched connection therebetween may be achieved easily.

To enable the box body 21a to be placed stably on the main body 1a, an abutting edge 14a may be arranged on a top of the shell 11a of the main body 1a. The abutting edge 14a may abut against the flange on the top of the box body 21a. In this way, the box body 21a may be placed stably.

In some embodiments, the shell 11a may define a clearance space 15a above the fourth latch portion 13a. The flange may be partially disposed within the clearance space 15a or extend above the clearance space 15a. The clearance space 15a may receive the hook, such that a sufficient engagement space may be provided for the hook.

After removing the cover body 22a, the user may store food in the containing chamber 200a in the box body 21a and may cover the box body 21a with the covering portion 221a. The user may then drive the first connection plate 222a and the second connection plate 226a to move downward, enabling the hook to be elastically engaged with the flange. In this way, the cover body 22a may be fixed to the box body 21a, and the food may be sealed. After the food is sealed, the user may place the box body 21a into the heating chamber 100a from top to bottom. During the above process, the first connection plate 222a may be vertically arranged. The connection plate 222a may move downward as the box body 21a moves, ultimately driving the fourth latch portion 13a (engagement tab) to be elastically engaged with the second latch portion 224a (engagement hole). In this way, fixation between the container box 2a and the shell 11a may be achieved. The second end 2222a of the connection plate 222a may be curved away from the shell 11a, and the end of the engagement tab away from the shell 11a may be curved downward. Therefore, during the above process, the second latch portion 224a and the fourth latch portion 13a may move downward to achieve engagement.

In some embodiments, the cover body 22a may be used as follows. After the food is placed into the box body 21a, the box body 21a may be placed into the heating chamber 100a. The cover body 22a may cover at a top of the box body 21a, each connection plate 222a may be driven to swing downward, enabling the hook to be elastically engaged with the flange and, at the same time, enabling the engagement tab to be elastically engaged with the engagement hole.

In some embodiments, the engagement hole and the engagement tab may be omitted. The hook may be directly elastically engaged with the abutting edge 14a to simultaneously secure the box body 21a and the main body 1a.

In addition, in the above embodiments, a heat-insulation gap 530a may be defined between the built-in power supply 5a and the heating module 3a to prevent the built-in power supply 5a from being damaged due to overheating. The built-in power supply 5a may be integrated with an independent power compartment. The power compartment may isolate the built-in power supply 5a from the heating module 3a. The power compartment may define at least one opening through which a wire may extend, and the wire may be arranged for electrical connection between the built-in power supply 5a and the control board 7a.

The present disclosure further provides a storage bag, which may have a two-layer storage spaces. A lower storage space may receive the above-described heating lunch box, and an upper storage space may receive beverages. An internal pocket may be arranged in the storage bag for storing ice packs, enabling the beverages in the upper storage space to remain cool or preserving freshness of food in the lower storage space.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A heating lunch box, comprising:
a main body, defining a heating chamber therein and forming a mounting port;
a container box, detachably mounted in the heating chamber and defining a containing chamber therein for receiving food;
a heating module, mounted in the main body and configured to heat the container box;
a touch screen module, mounted in the mounting port of the main body;
a built-in power supply, mounted in the main body;
a power switch, configured to turn on or off the built-in power supply;
a control board, electrically connected to the heating module, the touch screen module, the built-in power supply, and the power switch.

2. The heating lunch box according to claim 1, wherein, the main body comprises a shell and a first snap-fit structure; the mounting port is formed on the shell; the first snap-fit structure is disposed at an edge of the mounting port;
the heating lunch box further comprises a mounting assembly and a second snap-fit structure arranged on the mounting assembly; the touch screen module is fixedly mounted on the mounting assembly; the first snap-fit structure and the second snap-fit structure are snap-fitted to each other to secure the touch screen module to the mounting port.

3. The heating lunch box according to claim 2, wherein, the second snap-fit structure extends over the first snap-fit structure to further extend into the mounting port to abut an inner side of the first mounting port.

4. The heating lunch box according to claim 2, wherein, the mounting assembly comprises a plurality of frames; the control board, the touch screen module, and the second snap-fit structure are fixed to the plurality of frames.

5. The heating lunch box according to claim 1, wherein, the touch screen module is fixed, via adhesion, at the mounting port.

6. The heating lunch box according to claim 2, wherein, the touch screen module further comprises a touch display screen and an outer touch plate attached to an outer side of the touch display screen; the touch display screen is at least partially exposed from the mounting port to enable a user to perform operations thereon; the touch display screen is electrically connected to the control board, and the outer touch plate is made of a transparent material.

7. The heating lunch box according to claim 6, further comprising a switch button corresponding to the power switch; wherein, a through opening is formed in the outer touch plate, the switch button is exposed out of the main body through the through opening, the switch button is configured to be moved to trigger the power switch.

8. The heating lunch box according to claim 2, further comprising at least one of a power indicator light, a heating indicator light, and a charging indicator light; wherein, light emitted from each of the power indicator light, the heating indicator light, and the charging indicator light is capable of passing through the main body to reach an exterior of the main body; and each of the power indicator light, the heating indicator light, and the charging indicator light is electrically connected to the control board.

9. The heating lunch box according to claim 1, wherein, the heating module comprises a heating element and a heat-conducting member; the heating element is electrically connected to the control board; the heating element is configured to transfer heat to the heat-conducting member; the heat-conducting member is at least partially exposed from the heating chamber to contact the container box.

10. The heating lunch box according to claim 1, wherein, the container box comprises a box body and a cover body; the containing chamber is formed in the box body; the cover body is capable of covering the containing chamber; and the cover body is capable of covering to both the box body and the main body.

11. The heating lunch box according to claim 10, wherein, the cover body comprises a covering portion, a first connection plate movably arranged around the covering portion, a first latch portion and a second latch portion formed on the first connection plate; the covering portion is configured to cover the containing chamber;
a third latch portion is arranged on the box body, and the first latch portion is elastically snap-fitted to the third latch portion;
the main body comprises a shell and a fourth latch portion formed at an outer side of the shell; the second latch portion is elastically snap-fitted to the fourth latch portion.

12. The heating lunch box according to claim 1, wherein, a heat-insulation gap is formed between the built-in power supply and the heating module.

13. The heating lunch box according to claim 1, wherein, the main body is further arranged with a process, electrically or communicatively connected to the built-in power supply, the heating module, and the touch display screen.

14. The heating lunch box according to claim 13, wherein, the touch display screen is configured to display a heating setting interface for receiving at least one heating setting instruction input by user and display a heating interface which shows heating time related information.

15. The heating lunch box according to claim 14, wherein, the processor is configured to acquire at least a heating start time according to the heating time related information, and the heating module is configured to heat the food box accommodated in the accommodating cavity according to the heating start time.

16. The heating lunch box according to claim 15, wherein the heating start time is the current time.

17. The heating lunch box according to claim 15, wherein the heating start time is calculated based on a preset heating duration and the predetermined meal time.

18. The heating lunch box according to claim 14, wherein, the at least one heating setting instruction comprises an instant heating duration; the touch display screen is further configured to display an initial interface, wherein the initial interface provides an instant heating control, and when the instant heating control is triggered, the touch display screen is configured to display the heating setting interface; and the heating setting interface is configured to set the instant heating duration.

19. The heating lunch box according to claim 14, wherein the at least one heating setting instruction comprises a predetermined meal time; the touch display screen is further configured to display an initial interface, wherein the initial interface provides a time setting control, and when the time setting control is triggered, the touch display screen is configured to display the heating setting interface; the heating setting interface is configured to set the predetermined meal time.
